(19) United States
(12) Patent Application Publication
(10) Pub. No.: US 2010/0003587 A1
(43) Pub. Date: Jan. 7, 2010

(54) FOLDING SECONDARY BATTERY

(75) Inventor: Yih-Song JAN, Taipei City (TW)

Correspondence Address: BROWDY AND NEIMARK, P.L.L.C.;624 NINTH STREET, NW, SUITE 300, WASHINGTON, DC, 20001-5303, US

(73) Assignee: EXA ENERGY TECHNOLOGY CO., LTD., Taichung City (TW)

(21) Appl. No.: 12/497,029

(22) Filed: Jul. 2, 2009

(30) Foreign Application Priority Data
Jul. 4, 2008 (TW) 97211973

(51) Int. Cl. H01M 10/00

(52) U.S. Cl. 429/127

(57) ABSTRACT

A folding secondary battery includes a folded body mounted in a housing filled with an electrolyte solution. A positive electrode, two negative electrodes and two isolation films respective sandwiched between the positive electrode and one of the negative electrodes are laminated and folded to form the folded body with a zigzag shape. Films of positive active material are spacedly arranged on opposite sides of the positive electrode in a pair manner. On one side of the negative electrode facing the positive electrode, films of negative active material are spacedly arranged corresponding to the films of positive active material. The positive electrode and negative electrode are folded at a location between two of the films of positive active material and two of the films of negative active material respectively, thereby preventing detachment of the films due to fold and a deformation phenomenon under charging.

### BACKGROUND OF THE INVENTION

1. Field of the Invention

The present invention relates generally to a secondary battery and more particularly, to a folding secondary battery that has high structural stability and assures high level of safety.

2. Description of the Related Art

A conventional secondary battery 1, as shown in FIGS. 1 and 2, generally has a positive electrode 2, a first isolation film 3, a negative electrode 4 and a second isolation film 5 arranged in a stack and rolled up into a roll, which is then mounted in a housing 7 that is filled with an electrolyte solution 6 and sealed. The positive electrode 2 has a film of positive active material 8 covered on the surface of an aluminum base thereof. The film of positive active material 8 has a width smaller than the width of the aluminum base so that the positive electrode 2 has a bare aluminum region 9 defined at a top portion thereof. The negative electrode 4 has a film of negative active material 10 covered on the surface of a copper base thereof. The width of the film of negative active material 10 is smaller than the width of the copper base 4 so that the negative electrode 4 has a bare copper region 11 defined at a bottom portion thereof. Further, two conductive terminals 12 are respectively soldered to the laminated and layered bare aluminum region 9 and the laminated and layered bare copper region 11 after the roll is formed and extend out of the housing 7, forming a roll-up type rechargeable secondary battery.

The aforesaid conventional secondary battery is still not satisfactory in function. Because the positive electrode 2, the first isolation film 3, the negative electrode 4 and the second isolation film 5 are rolled up and flattened before insertion into the housing 7, the film of positive active material 8 and the film of negative active material 10 may be detached from the positive electrode 2 and the negative electrode 4 when they are folded, causing a short circuit. Further, the narrow elongated film of negative active material 10 will expand in dimension during charging. Expansion of the narrow elongated film of negative active material 10 due to charging may cause the negative electrode 4 or the housing 7 to deform.

### SUMMARY OF THE INVENTION

The present invention has been accomplished in view of the above-noted circumstances. It is an objective of the present invention to provide a folding secondary battery, which has high structural stability and assures high level of safety.

To achieve this objective of the present invention, the folding secondary battery comprises a positive electrode, two negative electrodes, two isolation films, a housing, an electrolyte solution, and two conductive terminals.

The positive electrode includes an aluminum foil with opposite first and second sides, and films of positive active material spacedly and respectively mounted on the first and second sides of the aluminum foil in a pair manner. Each film of positive active material has a width smaller than the width of the aluminum foil so that the positive electrode defines a bare aluminum region at the top portion thereof. The two negative electrodes are provided at two opposite sides relative to the positive electrode, each including a copper foil and a plurality of films of negative active material spacedly mounted on one side of the copper foil that faces the positive electrode and corresponding to the films of positive active material. Each film of negative active material has a width smaller than the width of the copper foil such that the negative electrode defines a bare copper region at a bottom portion thereof. The two isolation films are respectively sandwiched between the positive electrode and the two negative electrodes to isolate the positive electrode from the negative electrodes. The housing has an accommodation space that accommodates the positive electrode, the negative electrodes and the isolation films. The electrolyte solution is filled in the accommodation space of the housing. The positive electrode, the negative electrodes and the isolation films are laminated and folded into a continuously zigzag-shaped folded body such that a layered bare aluminum contact is defined at a top side of the folded body and a layered bare copper contact is defined at a bottom side of the folded body. One conductive terminal is electrically connected with the layered bare aluminum contact and extends out of the housing. The other conductive terminal is electrically connected with the layered bare copper contact and extends out of the housing.

### BRIEF DESCRIPTION OF THE DRAWING

The present invention will become more fully understood from the detailed description given herein below and the accompanying drawings which are given by way of illustration only, and thus are not limitative of the present invention, and wherein:

FIG. 1 is a perspective view of a secondary battery according to a prior art;

FIG. 2 is an exploded view of a part of the secondary battery according to the prior art;

FIG. 3 is an exploded view of a part of a folding secondary battery according to a first embodiment of the present invention, showing the structure and relative arrangement of positive electrode, negative electrodes and isolation films;

FIG. 4 is a top view of the assembly of positive electrode, negative electrodes and isolation films of the folding secondary battery in accordance with the first embodiment of the present invention;

FIG. 5 is an enlarged view of a part of FIG. 4;

FIG. 6 is a front view of the folding secondary battery in accordance with the first embodiment of the present invention;

FIG. 7 is a front view of a folding secondary battery in accordance with a second embodiment of the present invention;

FIG. 8 is a side view of the folding secondary battery in accordance with the second embodiment of the present invention;

FIG. 9 is a top view of an assembly of positive electrode, negative electrodes and isolation films of a folding secondary battery in accordance with a third embodiment of the present invention, and

FIG. 10 is an enlarged view of a part of FIG. 9.

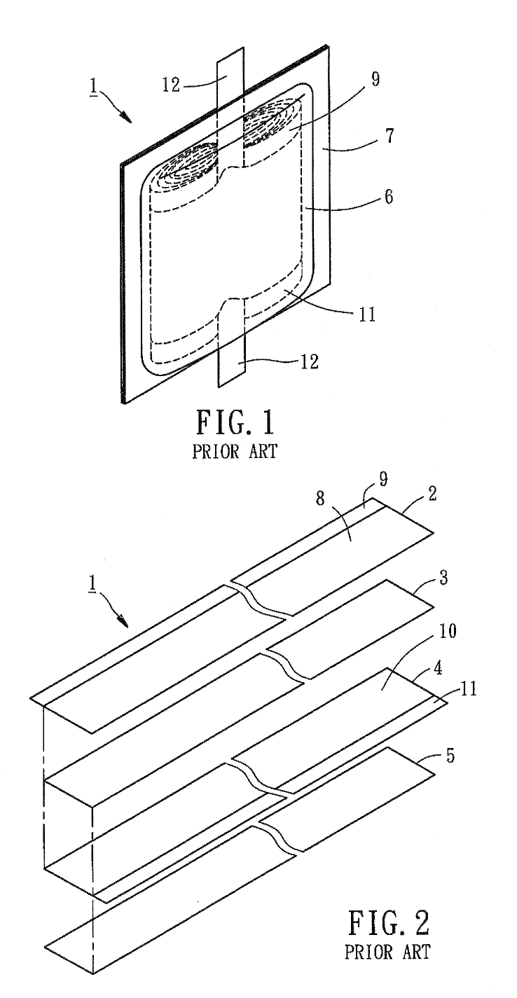

### DETAILED DESCRIPTION OF THE INVENTION

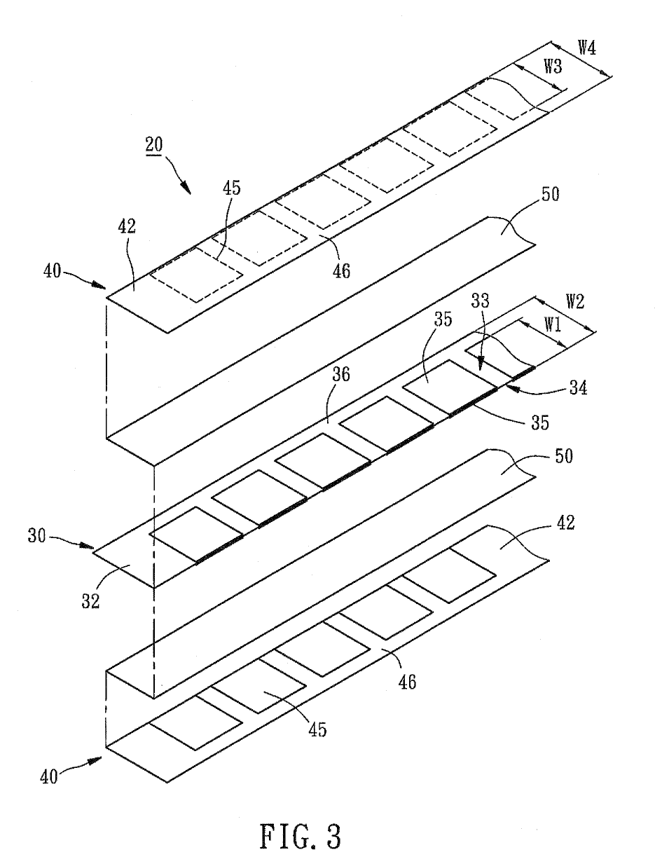

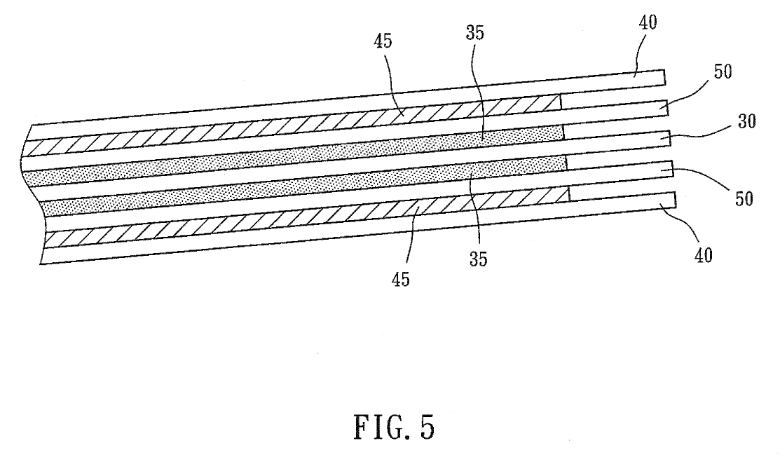

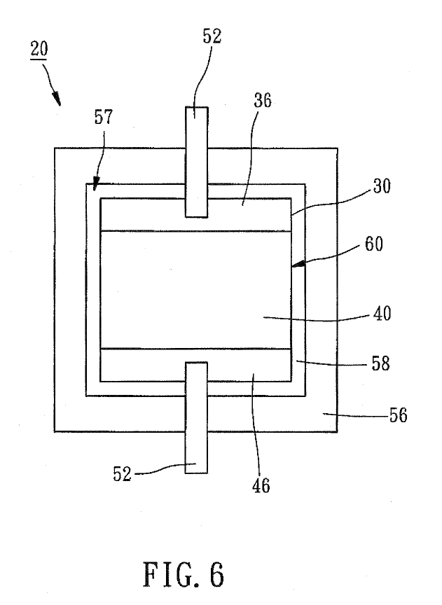

As shown in FIGS. 3-6, a folding secondary battery 20 in accordance with a first embodiment of the present invention comprises one positive electrode 30, two negative electrodes 40, two isolation films 50, two conductive terminals 52, a housing 56, and an electrolyte solution 58.

The positive electrode 30 comprises an aluminum foil 32 and multiple films of positive active material 35. The aluminum foil 32 has a first side 33 and a second side 34 opposite to the first side 33. The films of positive active material 35 are respectively symmetrically mounted on the first side 33 and the second side 34 of the aluminum foil 32 and equally spaced along the length of the aluminum foil 32 in a pair manner. Each film of positive active material 35 has a width w1 smaller than the width w2 of the aluminum foil 32 such that the positive electrode 30 has a bare aluminum region 36 defined at a top portion thereof. The films of positive active material 35 can be prepared from LiCoO₂, LiMnO₄, LiNiO₂, or LiCoₓNi₁₋ₓO₂. In actual practice, the positive active material can be selected from, but not limited to, lithium oxide, lithium sulfide, lithium selenide, lithium telluride, lithium ferrite phosphor oxide, lithium vanadium phosphor oxide of vanadium, titanium, chrome, copper, molybdenum, niobium, ferrite, nickel, cobalt or manganese.

The negative electrodes 40 are provided at two opposite sides relative to the positive electrode 30, each comprising a copper foil 42 and multiple films of negative active material 45 arranged on one side of the copper foil 42 that faces the positive electrode 30. The films of negative active material 45 are equally spaced from one another and respectively correspond to the films of positive active material 35 of the positive electrode 30. Each film of negative active material 45 has a width w3 smaller than the width w4 of the copper foil 42 such that the negative electrode 40 has a bare copper region 46 defined at a bottom portion thereof. The films of negative active material 45 can be prepared from MCMB, VGCF (vapor growth carbon fiber), CNT (carbon nanotube), charcoal, carbon black, graphite, acetylene black, carbon fiber, vitreous carbon, or a mixture thereof.

The two isolation films 50 are respectively sandwiched between the positive electrode 30 and one of the two negative electrodes 40 to isolate the positive electrode 30 from the negative electrodes 40.

The housing 56 is prepared from aluminum foil, defining therein an enclosed accommodation space 57 that accommodates the positive electrode 30, the negative electrodes 40 and the isolation films 50. The electrolyte solution 58 is also filled in the accommodation space 57.

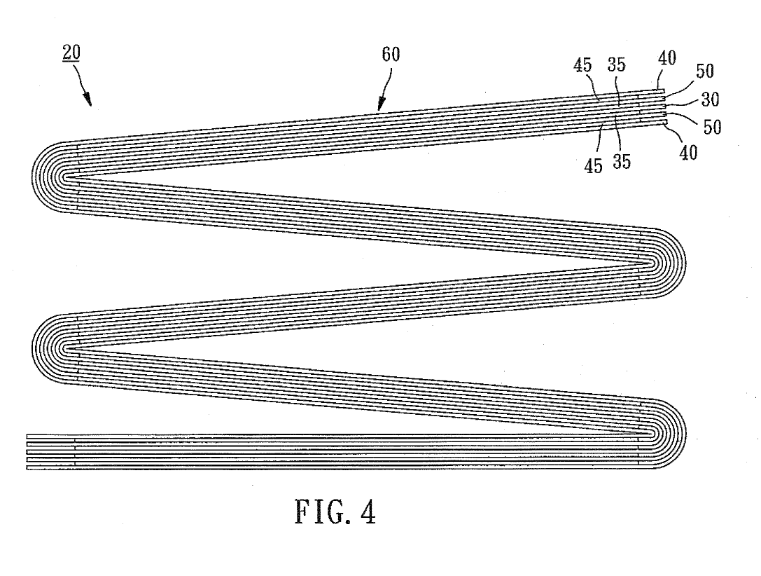

As shown in FIG. 4, the positive electrode 30, the negative electrodes 40 and the isolation films 50 are laminated together and folded into a continuously zigzag-shaped folded body 60 in which each folding location of the positive electrode 30 is located between two of the films of positive active material 35 and each folding location of each negative electrode 40 is located between two of the films of negative active material 45 so that the films of positive active material 35 and the films of negative active material 45 are kept intact and not been folded, avoiding detachment of the films 35 and 45 and assuring high level of safety.

After the folded body 60 is formed, the bare aluminum region 36 of the positive electrode 30 under fold forms a layered bare aluminum contact at the top side of the folded body 60 and the bare copper region 46 of the negative electrode 40 under fold forms a layered bare copper contact at the bottom side of the folded body 60. One conductive terminal 52 is soldered to the layered bare aluminum contact and the other conductive terminal 52 is soldered to the layered bare copper contact. In addition, the two conductive terminals 52 extend out of the housing 56.

Because the films of negative active material 45 of the secondary battery 20 are kept apart from one another at a distance, when the films of negative active material 45 are electrically charged to expand, the amount of deformation of the films of negative active material 45 does not cause the negative electrodes 40 or the secondary battery 20 to deform, assuring high level of safety.

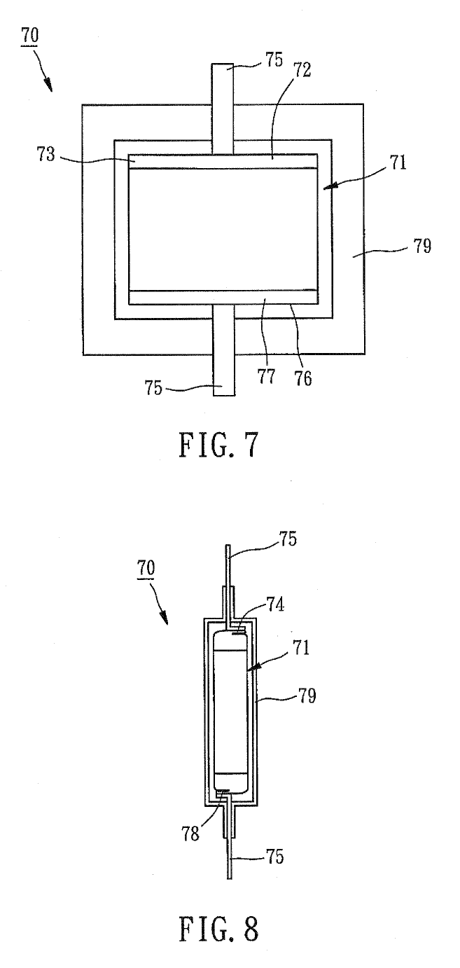

Base on the spirit of the present invention, the folding secondary battery may be variously embodied. FIG. 7 illustrates a folding secondary battery 70 in accordance with a second embodiment of the present invention. This second embodiment is substantially similar to the aforesaid first embodiment with the exception that, as shown in FIG. 8, the layered bare aluminum contact formed by the bare aluminum region 72 under fold at the top side of the folding secondary battery 70 is cut into a base 73 and a protrusion 74, and the protrusion 74 is bent through 90 degrees relative to the base 73 for the bonding of an L-shaped conductive terminal 75; the layered bare copper contact formed by the bare copper region 76 under fold is cut into a base 77 and a protrusion 78, and the protrusion 78 is bent through 90 degrees relative to the base 77 for the bonding of the other L-shaped conductive terminal 75. This second embodiment minimizes the dimension of the housing 79 without lowering the electric capacity, having great market potential.

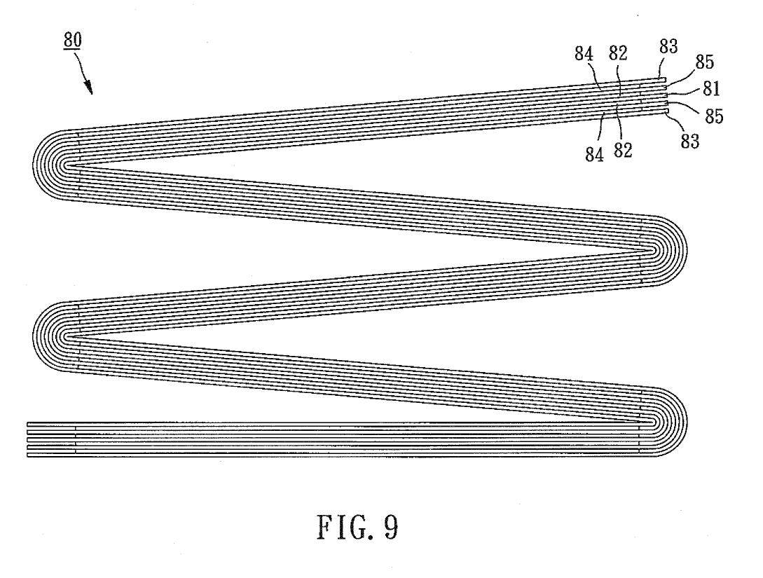

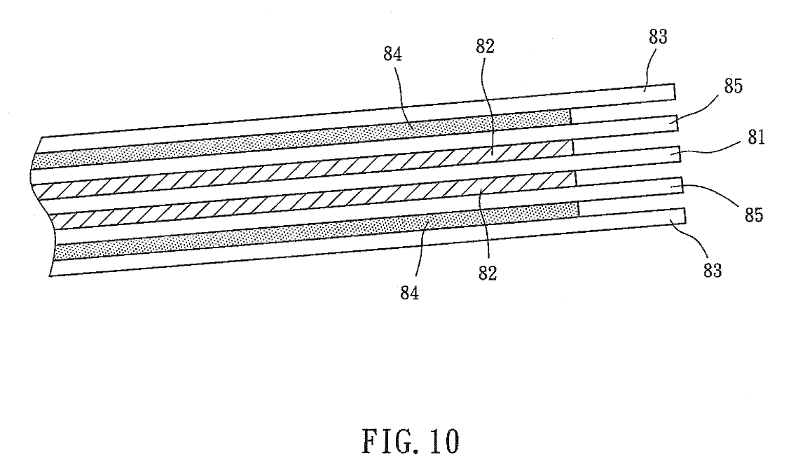

Further, the positions of the positive and negative electrodes in the aforesaid first embodiment may be exchanged to form another embodiment. FIGS. 9 and 10 show a folding secondary battery in accordance with a third embodiment of the present invention. According to this embodiment, the folding secondary battery 80 comprises a negative electrode 81, which comprises multiple films of negative active material 82 arranged on two opposite sides thereof and respectively equally spaced from one another at a distance in a pair manner, two positive electrodes 83 respectively arranged at two opposite sides relative to the negative electrode 81, each positive electrode 83 having multiple films of positive active material 84, two isolation films 85 sandwiched between the negative electrode 81 and the positive electrodes 83. The other structural arrangement of this third embodiment is same as the aforesaid first embodiment. This third embodiment achieves the same effects as the aforesaid first embodiment.

In the aforesaid many embodiments of the present invention, the size and shape of the bare copper region and bare aluminum region may be changed subject to requirements.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A folding secondary battery comprising:
a positive electrode having an aluminum foil with opposite first and second sides, and a plurality of films of positive active material spacedly and respectively mounted on the first and second sides of the aluminum foil in a pair manner, the films of positive active material each having a width smaller than that of the aluminum foil such that the positive electrode defines a bare aluminum region at a top portion thereof;
two negative electrodes provided at two opposite sides relative to the positive electrode, each said negative electrode having a copper foil and a plurality of films of negative active material spacedly mounted on the copper foil and respectively corresponding to the films of positive active material of the positive electrode, each of the films of the negative active material having a width smaller than that of the copper foil such that the negative electrode defines a bare copper region at a bottom portion thereof;
two isolation films respectively sandwiched between the positive electrode and the two negative electrodes to isolate the positive electrode from the negative electrodes;
two conductive terminals;
a housing having an accommodation space that accommodates the positive electrode, the negative electrodes and the isolation films; and
an electrolyte solution filled in the accommodation space of the housing;
wherein the positive electrode, the negative electrodes and the isolation films are laminated and folded into a continuously zigzag-shaped folded body such that a layered bare aluminum contact is defined at a top side of the folded body and a layered bare copper contact is defined at a bottom side of the folded body;
wherein one of the conductive terminals is electrically connected with the layered bare aluminum contact and extends out of the housing and the other conductive terminal is electrically connected with the layered bare copper contact and extends out of the housing.

2. The folding secondary battery as claimed in claim 1, wherein each folding location of the positive electrode is located between two of the films of positive active material.

3. The folding secondary battery as claimed in claim 1, wherein each folding location of the negative electrode is located between two of the films of negative active material.

4. The folding secondary battery as claimed in claim 1, wherein the layered bare aluminum contact comprises a base, and a protrusion extending from the base and electrically connected to the one of the conductive terminals.

5. The folding secondary battery as claimed in claim 1, wherein the layered bare copper contact comprises a base, and a protrusion extending from the base and electrically connected to the other conductive terminal.

6. A folding secondary battery comprising:
a negative electrode having a copper foil with opposite first and second sides, and a plurality of films of negative active material spacedly and respectively mounted on the first and second sides of the copper foil in a pair manner, the films of negative active material each having a width smaller than that of the copper foil such that the negative electrode defines a bare copper region at a top portion thereof;
two positive electrodes provided at two opposite sides relative to the negative electrode, each said positive electrode having an aluminum foil and a plurality of films of positive active material spacedly mounted on the aluminum foil and respectively corresponding to the films of negative active material of the negative electrode, each of the films of the positive active material having a width smaller than that of the aluminum foil such that the positive electrode defines a bare aluminum region at a bottom portion thereof;
two isolation films respectively sandwiched between the negative electrode and the two positive electrodes to isolate the negative electrode from the positive electrodes;
two conductive terminals;
a housing having an accommodation space that accommodates the negative electrode, the positive electrodes and the isolation films; and
an electrolyte solution filled in the accommodation space of the housing;
wherein the negative electrode, the positive electrodes and the isolation films are laminated and folded into a continuously zigzag-shaped folded body such that a layered bare copper contact is defined at a top side of the folded body and a layered bare aluminum contact is defined at a bottom side of the folded body;
wherein one of the conductive terminals is electrically connected with the layered bare copper contact and extends out of the housing and the other conductive terminal is electrically connected with the layered bare aluminum contact and extends out of the housing.

7. The folding secondary battery as claimed in claim 6, wherein each folding location of the negative electrode is located between two of the films of the negative active material.

8. The folding secondary battery as claimed in claim 6, wherein each folding location of the positive electrode is located between two of the films of the positive active material.

9. The folding secondary battery as claimed in claim 6, wherein the layered bare aluminum contact comprises a base, and a protrusion extending from the base and electrically connected to the other conductive terminal.

10. The folding secondary battery as claimed in claim 6, wherein the layered bare copper contact comprises a base, and a protrusion extending from the base and electrically connected to the one of the conductive terminal.
